(19) United States
(12) Patent Application Publication
(10) Pub. No.: US 2012/0254404 A1
(43) Pub. Date: Oct. 4, 2012

(54) MULTI-TIERED AUTOMATIC CONTENT RECOGNITION AND PROCESSING

(75) Inventors: Michael Shane Wilkinson, Nehall, CA (US); Thomas Bause, Brooklyn, NY (US); Arturo Vermolen, Long Island City, NY (US); Sheau Ng, Wayland, MA (US); John Sullivan, Ridgewood, NJ (US)

(73) Assignee: NBCUniversal Media LLC, New York, NY (US)

(21) Appl. No.: 13/101,643

(22) Filed: May 5, 2011

Related U.S. Application Data
(60) Provisional application No. 61/471,583, filed on Apr. 4, 2011.

(51) Int. Cl. G06F 15/173

(52) U.S. Cl. 709/224

(57) ABSTRACT

A multi-tiered approach to identifying digital content and acting upon the identification includes transmitting data from a device on which the content is stored or played to a first tier entity where the content and the device are identified. The first tier entity may use any one of many techniques for identifying the data and device. Once the identification data is determined, the information is transmitted to any one of multiple second tier entities that work in cooperation with the first tier entity. The second tier entities may then perform any desired functions based on the identification, such as providing offers, content, products and/or services to the device, or to other devices associated with the device or the device user. Other tiers may be employed for carrying out particular functions or activities, such as under the direction of the second tier entities.

### CROSS REFERENCE TO RELATED APPLICATIONS

This application is a Non provisional of U.S. Provisional Patent Application No. 61/471,583, entitled “Multi-Tiered Automatic Content Recognition and Processing”, filed Apr. 4, 2011, which is herein incorporated by reference.

### BACKGROUND

The invention relates generally to content delivery and monitoring, and more particularly to highly flexible techniques for monitoring audience enjoyment of content for delivery of complimentary content and/or services.

The field of content delivery has evolved greatly over recent years. From traditional print and broadcast media, new arrangements have been developed for delivery of content in many forms, including in written, audio, video, still pictures, and so forth. These developments have resulted in a myriad of different delivery channels, business and commercial arrangements, devices for the enjoyment of content, and so forth. Not only has this enhanced the flexibility of audiences in terms of taste and timing, but it has introduced much greater potential for adapting content and services for particular consumers.

There is considerable interest in, and the field has focused on, the ability to offer additional content and/or services to particular audiences, or even to particular individuals based upon observed interests, as indicated, for example, by content that is consumed. In general, such content may be consumed by viewing, listening, reading, or any activity that is appropriate to the form of delivery. Moreover, the content may be consumed during a broadcast (to multiple consumers at once), during limited or subscription transmissions, during transmission by individualized digital means (e.g., via the Internet), “on-demand” content (via the Internet, cable or another medium) or in many recorded forms (e.g., e-books, recorded movies and television shows, from electronic recordings on various supports, and so forth). Based upon knowledge of such interests, additional content and/or services may be offered to the audience, advertisements may be adapted, or additional information may simply be provided that may enhance the audience experience.

A continuing difficulty in such delivery schemes is the highly fractured nature of the industry, and particularly the great variety of content owners, content providers, delivery channels, delivery media and technologies, and consumption devices. For example, different content owners or licensees, or the providers who deliver their content are typically interested in ensuring delivery of their own content, and may be in a position to monitor consumption of that content, although often to a very limited extent. Consumers, on the other hand, are prone to turn to many different content owners and providers, and may be completely unconcerned and even unaware of the particular originator of the content. Moreover, audiences may switch often and rapidly between particular content, particularly audio and video content. Such flexibility, which is highly valued by audiences, may thwart systems designed to provide complementary content and/or services.

For example, a television viewer be interested in a particular program, and during viewing of that program, a content owner or provider may be able to detect the content being viewed, devices available to the viewer, viewer taste, and other relevant information, and provide offerings based upon it. When the viewer changes to a different program, however, the new program may be offered by a different content owner, or even a different provider. This is particularly true as consumer electronic devices (such as televisions, set-top boxes, mobile devices, computers, tablets and the like) become capable of receiving content from different media and by different technologies (e.g., broadcast, satellite, cable, mobile networks, the Internet, and other networks). Due to the vertically integrated nature of the detection and complementary content delivery systems currently contemplated, such systems are simply incapable of serving audiences in a consistent manner over the range of possible audience options available.

There is a need in the field for improved techniques for monitoring consumption of digital content, and for channeling information related to the appropriate entities that may provide complementary content and/or services.

### BRIEF DESCRIPTION

The present invention provides novel systems and methods designed to respond to such needs. The techniques offered may be implemented in a range of environments, with a wide range of media and content, as well as with any suitable delivery mechanisms, technology and devices. The techniques allow for a tiered approach to identifying content being received or played by consumer electronic devices, and then passing along such information to stakeholders who, in a separate “tier” may process and/or act on the information, such as to direct complementary content to the same or other devices. Such activities may, in turn, be performed by a further tier. The approach substantially frees the content owners, distributors, aggregators, rights holders, and providers from the need to vertically integrate the content identification function, and allows for much broader adaptability of content identification to serve a range of content owners, controllers and providers. It also allows for specialization of content and service providers, who may offer their technologies in tiers that serve the owners, controllers and providers of the underlying content and/or any complementary content or services. The techniques also allow for much more comprehensive identification of content, as well as monitoring of audience interest, reporting of interest or use, advertising effectiveness, and so forth.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary multi-tiered content recognition and processing system in accordance with aspects of the present techniques; and

FIG. 2 is a flow chart illustrating exemplary logic for carrying out some of the functionality offered by the multi-tiered approach.

### DETAILED DESCRIPTION

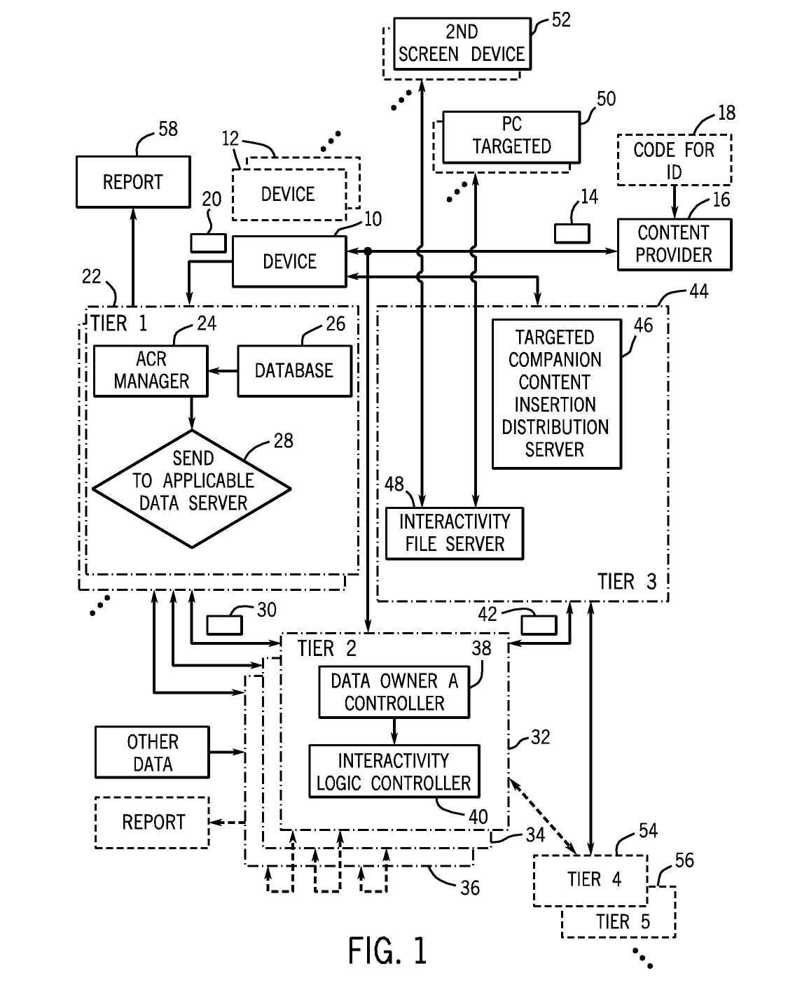

Turning to the drawings, FIG. 1 represents an exemplary multi-tiered system for monitoring the consumption of digital content, identifying the content, and acting on the identification. The system is illustrated as serving an electronic device 10, which may typically be a consumer electronic device, although the invention is not limited to any such device or device category. Additional devices 12 may be serviced, as indicated below. The devices may include, without limitation, televisions, radios, computers, smart phones, various playback and receiving devices, and so forth. Content 14 is delivered to the device from a content provider 16. The content provider may be any current (or future) type of provider, such as broadcasters, cable and satellite providers, Internet service providers, cellular telephone providers, and so forth. Moreover, the provider may utilize any appropriate media, channels, or technologies for delivery of the content, such as conventional airwave broadcast, cable and satellite transmission, digital (e.g., Internet protocol) transmissions, cellular protocols, and so forth. Indeed, it is contemplated that multiple, and possibly very many, providers may offer the content 14 to the device, with the device being capable of selecting between any such content, switching between providers, or even receiving content from multiple providers at once. It should also be noted, however, that the content may be enjoyed by the audience associated with the device in real time or near real time, as it is transmitted, but may also be stored, time shifted, or otherwise managed by the device 10, or any of a range of components associated with the device. For example, the content 14 may be stored on the device, stored on various supports (e.g., CD's, DVD's, computer memory, memory of the device 10 or of a provider, such as through “record” instructions of the user), or recorded or stored in accordance with developing cloud storage technologies. It should be noted that all of the devices affected by the present techniques may be considered to be connected devices in the sense that they can either transmit or receive data, or both, although not all of the devices need to be connected simultaneously.

As discussed below, the system will allow for identification of the content 14. In certain embodiments, to facilitate such identification, particular code may be provided that can be embedded into the content, as indicated by reference numeral 18. This code may originate with the provider 16, or could be provided by a separate entity. Various types of identification code or data may be utilized, and such data may be carried by various mechanism (e.g., mechanisms sometimes be referred to as “watermarks”) and the technologies for their creation and embedding are generally known in the art.

The device 10, or a component associated with the device (e.g., set-top box, playback device, etc.) may extract information 20 that can be used to identify the content 14 then being played on the device. The present techniques are extremely flexible, however, in terms of the type of information that may be used to identify the content. For example, where the content contains identifying data carriers (e.g., watermarks), such data may be extracted, or information based on such data may be generated in the device 10. Where such data is not available, other mechanisms, such as digital fingerprints, may be used for identification purposes. Such fingerprints, and the mechanism for their generation are generally known in the art. Such identifiers may, for example, be based on analysis of digital code for particular scenes in still images and video content, sections of audio content, and so forth. Similarly, certain content may itself include metadata that may permit its identification. In certain implementations, the information 20 may simply include a sample of the content that can itself be analyzed by a tier 1 entity as described below. This may be the case, for example, where the device 10 is not itself capable of extraction of the desired information.

It should be noted that reference is made in the present discussion to “playing” content on electronic devices. When used, that term is intended to extend broadly to rendering, reproducing, displaying or running content. Depending upon the application and the distribution technology, such content may be played in real time or near real time, and or may be stored on the electronic device or elsewhere for later playing. Such playing may consist of reproducing audio components, video components, textual components or any combination of these or any other form of content. The term is not intended to relate to simple display of electronic messages, however, such as email, although it may extend to playing audio, video or multimedia attachments to such transmissions.

It should also be noted that while, as mentioned, the tier 1 entity is advantageously adapted to use multiple techniques (e.g., watermarks, fingerprints, embedded code) for the identification of the content and the device, a combination of such techniques may be used to glean additional, complementary or confirmatory information from the content. For example, to service certain tier 2 entities, as discussed below, the tier 1 entity may desire to identify not only the content and device, but the originator (e.g., television channel, cable provider, etc.), and such information may be available from such other data.

The information 20 thus includes this data that can be used as a basis for identifying the content 14, as well as data identifying the device 10. The latter data may originate in the device itself, or may be associated with the device by virtue of any subscriptions to which the device is party, networks on which the device operates, and so forth. In certain implementations, the data may be associated with the device permanently or temporarily stored on the device or for the device, such as cookies, session identifiers, and so forth.

The information 20 is provided to a tier 1 entity 22. This entity will consist of and utilize appropriately programmed computers and servers adapted for identifying the content and device, based upon the received information. The tier 1 entity may, in some implementations, comprise a number of different processing locations, or may be centralized. The entity 22 thus includes an automatic content recognition (ACR) manager 24, which itself will typically comprise one or more programmed computers or servers that receive the information 20, and that identify the content and device. The information may be transmitted to the tier 1 entity 22 by any suitable means, such as wired and wireless connections, cable and satellite links, cellular networks, and so forth. Indeed, the media and transmission mechanisms may be the same as those used to deliver the content 14 to the device, or different from these.

Based upon the received information, the ACR manager 24 identifies the content by reference to stored information, such as a database 26. This information may reference one or more of the watermarks, signatures, metadata, or any other data associated with the content. In practice, it may be difficult or impossible for all available content to be identified, although the present approach is designed to allow cooperation between many different content owners, controllers and providers, each of whom may communicate any useful identifying data to the tier 1 entity for identification purposes. It should also be noted that the database 26 need not be monolithic, but could include a number of resources both internal to and external from the tier 1 entity.

Based upon the identification, as indicated by reference numeral 28, the tier 1 entity 22 sends the identification data, and any device-identifying data, represented collectively by reference numeral 30, to any one of multiple tier 2 entities 32, 34 and 36. Such entities may be, for example, owners, distributors, aggregators, rights holders, or upstream providers of the content 14. In general, each of the entities may be anyone having a need or desire to monitor the content 14 played on the device 10. While any of the tier 2 entities may also carry out the functionality of the tier 1 entity, the present approach contemplates a much more dynamic, flexible and powerful arrangement in which the tier 1 entity acts as a clearinghouse for the content identification, while the tier 2 entities may be co-contracting parties to whom the tier 1 entity provides the identification service. Similarly, as illustrated, it is contemplated that any number of tier 1 entities may participate in the system, each possibly serving its own tier 2 entities, or serving the same, or some of the same tier 2 entities.

It should also be noted that the approach represented by the tier 1 and tier 2 entities makes possible new and extremely useful data processing and business cases. That is, tier 2 entities that may not be interested or capable of the sophisticated processing performed by the tier 1 entity may contract or otherwise participate in the identification and monitoring process, and offer additional content and/or services. Similarly, tier 2 entities may comprise companies that in some ways compete with one another and that may not otherwise be comfortable sharing information with other tier 2 entities needed for identification of their own content. The use of the tier 1 entity, then, permits a buffer between such tier 2 entities, perhaps enhancing the opportunities for all in participating in the system. Still further, the particular activities of the tier 2 entities may vary widely, depending upon the type of business plan, product or service offerings, and so forth envisioned by the tier 2 entities. Indeed, the particular use of the identification data need not be shared with the tier 1 entity, and may change over time.

It should be noted that reference is made in this discussion to certain “services, “products” and related “functions” that may be performed by the various tier entities. When used, these terms should be understood broadly. That is, services, products and functions may include new product and/or service offerings, the provision of existing or enhanced products and/or services, the provision of information that may be of interest to users of the electronic devices, or the provision of service and/or products or offers for these to other devices in any way associated with the electronic devices identified (e.g., having the same owner or user, on the same network, in the same geographic or demographic segment, having similarities with the electronic device information sufficient to support the provision of the service and/or product function). This aspect of the system and its operation may include opt-in and opt-out functionality (in which a user may express a desire to receive or not to receive additional information, products and/or services), and may or may not be interactive (supporting two-way exchange of data). The particular form and process of this provision of product and/or service functions may, of course, follow the type of electronic device identified and its capabilities for accepting and/or responding to the information or functions. Finally, in some contexts, it may be useful and desirable to craft the functions performed by one or more tiers based on information known or discernable from the identification of the content, or the device, or both, or based upon data or metadata associated with these. That is, for example, if the gender or particular preferences of a user are known, the functions performed may be particularly directed to that category or class of users in a targeted manner.

Each tier 2 entity will typically comprise a data owner controller 38 (illustrated as an owner “A” controller for the first tier 2 entity 32 in FIG. 1). It should be noted that, although the term “owner” is used in FIG. 1, more generally, this controller may belong to or serve any particular stakeholder, such as content owners, content rights holders (e.g., licensees), providers, or anyone else interested in the consumption of the content 14. The controller itself will typically include one or more programmed computers, servers, or any associated components. The controller will further include, or cooperate with one or more logic controllers 40, which may be defined by appropriate programming code implemented by the controller. In general, any desired activities may be defined by the controller 40, depending upon the nature of the particular tier 2 entity, its business objectives, and so forth. For example, the controllers 38 and 40 may call for logging only of the use of the content 14 by the device 10. However, it is contemplated that in most cases, the tier 2 entity will desire to have some additional activity performed, such as provision or offering of additional content, services, advertisements, promotions, and so forth that could be of interest to the user of the device 10. Decisions on any such activities may be based on the identification of the content and the device, but also on additional data, as indicated in FIG. 1. Such additional data may include, for example, information accessible by the tier 2 entity relating to the device or a particular user or account, historical information, tendencies, and preferences of the device or a user, subscriptions or rights of the device or user, demographic data, location data (e.g., where a mobile device is then located), and so forth. Similarly, one or more of the tier 2 entities may make use of one or more databases that may contain information similar to that of the tier 1 entity, but for their own needs (e.g., devices, users, content, activities of interest based upon such information, etc.).

It should be noted that various approaches may be employed for cooperation between the tier 1 entity and the tier 2 entities. For example, as noted above, data may simply be passed from the tier 1 entity to the tier 2 entities. However, other techniques, such as a session hand-off may be employed, in which the tier 2 entity simply takes over communication with the device 10 once the content and device are identified. It should also be noted that communications may, of course, take place between various tier 2 entities, depending upon their relationship, their business interests, their mutually agreed functions, and so forth.

Based upon the logic implemented by the tier 2 entity, then, further tiers may be invoked by passing along data or instructions 42 to one or more tier 3 entities. Here again, the data may include identification of the content 14, and the device 10. Additional information may be included in the instructions 42, such as particular activities to be carried out by the tier 3 entity. In certain implementations, the tier 2 entity may itself perform such functions, although the embodiment illustrated in FIG. 1 contemplates cooperation between other, perhaps more specialized entities at a tier 3 level. Such entities, for example, may specialize in the offering of particular content, products and/or services. Moreover, the tier 3 entities may contract or otherwise arrange with the tier 2 entities for the provision of offering of the content, products and/or services, permitting further monetization of the content owned or controlled by the tier 2 entity.

In the illustrated embodiment, the tier 3 entity 44 includes a targeted companion content insertion distribution server 46. This server may draw from additional content, such as informational content, offerings, promotions, and so forth, that may be sent to the device 10, or to another device 12 based upon the identification of content 14 and device 10. By way of example only, information may be inserted into the content 14 (e.g., played with, overlayed, interleaved with the content). Moreover, the present techniques also contemplate such activities as ad replacement, in which a scheduled advertising slot in content 14 may be filled with a different ad by server 46, depending upon the identified content, the device, and the possible interests of the device user. In the case of other devices 12, the additional content may be sent to any such device, such as telephones, computers, handheld devices, and so forth, for presentation to the user or for interactive data exchange. It should also be noted that any such transmissions may be made by the same or different media as that used to receive content 14. Indeed, as noted above, content 14 need not be played at the time received by the device 10, but may be stored, time shifted, and so forth. The activities executed by the tier 2 and tier 3 entities may thus be free of any particular broadcast schedule, data transmission timing, and so forth.

As also illustrated in FIG. 1, the tier 3 entity may include an interactivity file server 48 designed to coordinate interactive activities with the device 10 or any other device, such as targeted computers 50, second screen devices 52, and so forth. These components may then cooperate with devices 12 for interactive sessions in which the user is provided with information, offers, products, content, or any other item of possible interest. In certain contexts, such devices may not be considered as part of the tier 3 entity, or the tier 3 entity may, instead, be considered to have specialized modules (e.g., computers, servers, routines) for communicating with such devices. Such modules may themselves implement sophisticated activity schemes, such as tailoring offers based upon the known or likely user gender, known characteristics of the user, and so forth. Many scenarios may be envisioned for these purposes, such as those outlined in U.S. patent application Ser. No. 12/635,229, entitled “Viewer-personalized Broadcast and Data Channel Content Delivery System and Method”, filed on Dec. 10, 2009 by Ng et al., which is hereby incorporated into the present disclosure by reference.

In addition to the use scenarios discussed above, it should also be noted that the techniques, and particularly the multi-tiered approach, may be used in conjunction with social networking applications as well. For example, cooperating users on of such applications or sites may wish to know and even follow what content they are each viewing or otherwise consuming. The content recognition functions of the tier 1 entity may allow for content to be identified that one user is viewing, for example, and then by cooperation with the entities of other tiers, other connected users may be informed of the user/content activity (e.g., “Did you know that your friend is watching XXX. Do you want to chat with her?”). Similarly, one user may inquire via an application whether any associated users are currently watching the same content, and receive a response based upon the content recognition functions carried out by the tier 1 entity.

As noted above, further tiers may be invoked or spawned, as indicated by reference numerals 54 and 56. Such other tiers may correspond to specialized entities that offer or provide additional content, products and/or services to the device 10, devices 12, or to the same or other users. This invocation may occur based, for example, upon identification that the user has such other devices, that the user is on-line or otherwise available on such devices, and so forth. As with the relationships between the tier 1, tier 2 and tier 3 entities, then, the system offers many possible arrangements for cooperation between entities that may need or want to communicate and/or cooperate with device 10 or any other devices 12, typically for a targeted user or audience.

The present approach also offers highly valuable tools for monitoring the content 14 and evaluating the audience for such content. For example, as indicated by reference numeral 58, a reporting function may be carried out by the tier 1 entity. Here again, the tier 1 entity need not have a particular stake in the success of the content, or upon any offers or provision of content, products and/or services, but may simply report to others content-related parameters, such as audience size, audience demographics, audience interest, and so forth. By way of example, before, during or after the cooperative relationship between a tier 2 entity and the tier 1 entity, the tier 1 entity may report on the number and quality of content identifications made, activities performed, and so forth. Such reports may serve to allow the tier 2 entity to determine whether to initiate the relationship with the tier 1 entity, whether to continue the relationship, or whether to alter the type and focus of the relationship (e.g., the number and designations of the particular content monitored by the tier 1 entity). It should be noted that entities at all tiers may be designed to carry out such reporting functions as well. Such reporting may enable reporting for both up and downstream tiers, as well as tracking of the effectiveness of that tier entity's own activities.

It should be noted that similar reporting functions may be carried out by other tiers in the system. Such reporting may include “reporting up” to upstream tiers (i.e., those that receive information and provide direction to others for action) and “reporting down” to downstream tiers (i.e., those that follow the direction for action from others). The reporting may be performed internally within a tier as well, both within a single entity and between entities (“peers” or competitors) at a particular level. It should also be noted that reporting may be performed between tiers, bearing in mind that one entity may function as “upstream” to another on one context or function, or as “downstream” or at a “peer” level in another context or function. As noted in the present discussion, such reporting may focus on measurement of such factors as content interest (e.g., number of times the content is played by a device or audience), rather than or in addition to actions taken by one or more tier entities.

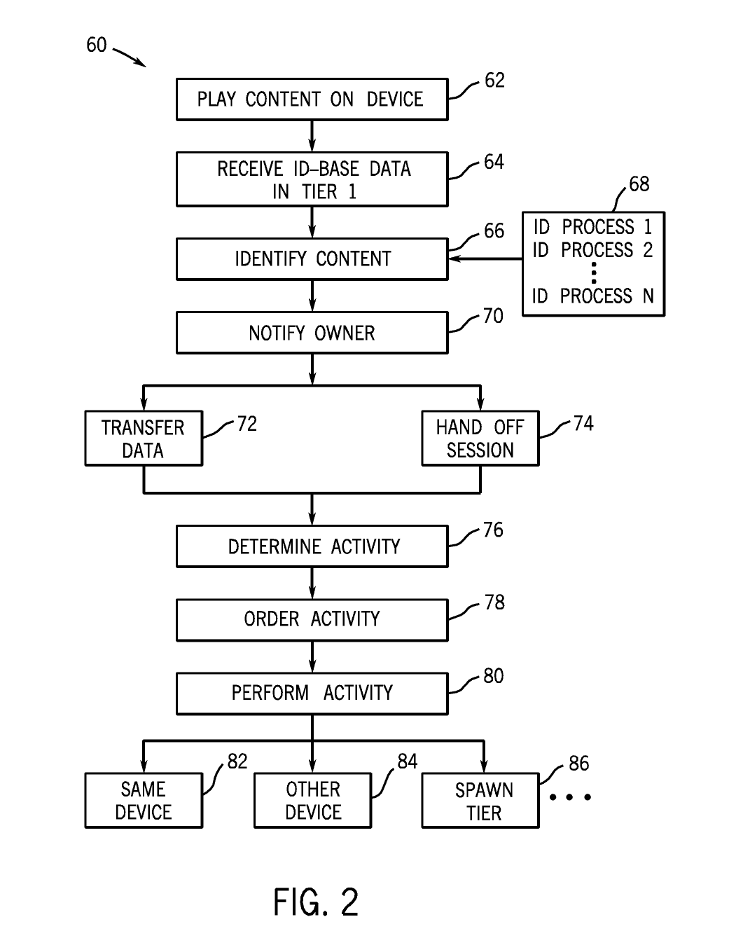

FIG. 2 is a flow chart illustrating exemplary logic 60 for performing certain of the multi-tiered functions outlined above. The processing begins with playing content on the device, as indicated at step 62. As noted above, the content may be of any desired type, as may the device. Moreover, the content may be played as received by the device, or may be played from any storage devices, such as within the device itself, or from a component coupled to the device, or completely separate from the device. At step 64, then, the data on which the content identification will be based is transmitted from the device (or a component associated with the device) to the tier 1 entity. As noted above, data may be of a type that allows for any of a range of identification techniques, any and all of which may be utilized by the tier 1 entity for identification of the content and the device. Such data may include, for example, digital watermarks, signatures, and so forth.

Based upon this data, the tier 1 entity identifies the content as indicated at step 66. Here again, the tier 1 entity may be adapted to utilize more than one, and potentially many different techniques, depending upon the data available for content identification. These may be specified by the tier 1 entity, specified by the tier 2 entity, or dictated by the content or content type. The tier 1 entity then notifies the stakeholder (e.g., the content owner, controller, provider, or any other interested tier 2 entity) as noted at step 70. Here again, this notification may be performed in real or near-real time (i.e., during the play of the content) or in the form of reports. In the former case, which may be more useful for most tier 2 (and downstream tier) entities, activities defined by the tier 2 (and downstream tier entities) may be performed while the content is played on the device or later.

As indicated by steps 72 and 74, then, various interactive operations may be performed between the tier 1 entity and the appropriate tier 2 entities. These may include, for example, simple transfer of data identifying the content and device. In other contexts, sessions may be handed off from the tier 1 entity to the tier 2 entity.

Once the tier 2 entity has been informed of the content and device, the tier 2 entity may perform any operations it deems useful, as determined by the logic it implements, its business interests, the particular content identified, the device identified, and any other information considered by the tier 2 entity (e.g., current offers, demographics, history of interests of the device or user, etc.). The tier 2 entity may then proceed with such activities, or may order the activities to be performed by other, tier 3 entities, as indicated by step 78. In either case, the activity will be performed at step 80 as discussed above. As also discussed above, the activity may involve transmitting content, initiating interactive data exchange or otherwise communicating with the same device, or with a different device, as indicated by blocks 82 and 84. Moreover, as also noted above, the activity may call for invoking one or more additional tier, as indicated by block 86, such as to allow entities at such tiers to perform activities of their own based upon the identified content, the device, and any other data considered by an entity at any one of the tiers.

By way of example, a television network may cooperate with various advertisers that each act as (or contract with) its own tier 3 entity. Such advertisers may, then, receive “live user” data or a connection from the tier 2 network, and each advertiser may choose to offer highly dynamic and targeted offers to the users, thereby creating a dynamic ad campaign that suits their individual business interests. Today, such campaigns are typically run in close coordination with television networks, and not independently in this novel manner. Such specialization and adaptability may continue to further levels, such as to local supply and commercial establishments, which may be considered to constitute tier 4 entities, and so on.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A multi-tiered automatic content recognition and processing method, comprising:
in a first tier entity, receiving electronic device data;
analyzing, in the first tier entity, the electronic device data to identify the electronic device and data indicative of digital content being played on the electronic device;
analyzing, in the first tier entity, the data indicative of the digital content to identify the digital content; and
transmitting from the first tier entity to an appropriate one of a plurality of second tier entities the identity of the electronic device and the identity of the digital content to facilitate activity between the second tier entity and the electronic device based upon the identified content.

2. The method of claim 1, wherein the content is identified by identification code embedded in the content.

3. The method of claim 1, wherein the content is identified by a digital watermark.

4. The method of claim 1, wherein the content is identified by a digital signature created by the electronic device or by the first tier entity.

5. The method of claim 1, comprising selecting, in the first tier entity, one of a plurality of content identification techniques based upon the electronic device data, and wherein the digital content is identified based upon the selected content identification technique.

6. The method of claim 1, wherein the digital content is identified based upon more than one content identification techniques.

7. The method of claim 1, comprising selecting the appropriate one of the plurality of second tier entities based upon the identity of the digital content.

8. The method of claim 1, comprising reporting to each of the plurality of second tier entities data indicative of at least a number of incidents of identification of an electronic device and digital content for each respective second tier entity.

9. The method of claim 1, wherein the first tier entity provides code to a provider of the digital content for facilitating identification of the digital content by the first tier entity.

10. A multi-tiered automatic content recognition and processing system, comprising:
in a first tier entity, a database comprising data corresponding to digital content of a plurality of second tier entities;
in the first tier entity, a content recognition component configured to receive electronic device data, to analyze the electronic device data to identify the electronic device and data indicative of digital content being played on the electronic device, and to analyze the data indicative of the digital content to identify the digital content based upon the database; and
in the first tier entity, a transmission component configured transmit to an appropriate one of the plurality of second tier entities the identity of the electronic device and the identity of the digital content to facilitate activity between the second tier entity and the electronic device based upon the identified content.

11. The system of claim 10, wherein the content identification component selects one of a plurality of content identification techniques based upon the electronic device data, and wherein the digital content is identified based upon the selected content identification technique.

12. The system of claim 10, wherein the content identification component identifies the digital content based upon more than one content identification techniques.

13. The system of claim 10, comprising a plurality of second tier entities linked to allow for data exchange with the first tier entity, the first tier entity selecting the appropriate one of the plurality of second tier entities for data transmission based upon the identity of the digital content.

14. The system of claim 13, wherein the second tier entities are configured to perform services, or to offer services or products to the identified electronic devices based upon the identified digital content.

15. A multi-tiered automatic content recognition and processing method, comprising:
in a first tier entity, receiving electronic device data, analyzing the electronic device data to identify the electronic device and data indicative of digital content being played on the electronic device, analyzing the data indicative of the digital content to identify the digital content, and transmitting from the first tier entity to an appropriate one of a plurality of second tier entities the identity of the electronic device and the identity of the digital content to facilitate activity between the second tier entity and the electronic device based upon the identified content; and
in at least one of the second tier entities performing a product and/or service function based upon the identified digital content, or coordinating with a further tier entity to do so.

16. The method of claim 15, wherein the second tier entity performs the product and/or service function or coordinates with a further tier entity to do so via communication with the electronic device.

17. The method of claim 15, wherein at least one of the second tier entities performs the product and/or service function or coordinates with a further tier entity to do so via communication with a different electronic device.

18. The method of claim 15, wherein for identification of the content, the first tier entity references a database that comprises data provided by each of the second tier entities for identifying its digital content.

19. A multi-tiered automatic content recognition and processing system, comprising:
a first tier entity configured to receive electronic device data, to analyze the electronic device data to identify the electronic device and data indicative of digital content being played on the electronic device, to analyze the data indicative of the digital content to identify the digital content, and to transmit from the first tier entity to an appropriate one of a plurality of second tier entities the identity of the electronic device and the identity of the digital content to facilitate activity between the second tier entity and the electronic device based upon the identified content; and
a plurality of second tier entities configured to perform a product or service function based upon the identified digital content, or coordinating with a further tier entity to do so.

20. The system of claim 19, comprising at least one additional tier entity in data communication with at least one of the second tier entities and configured to perform a product and/or service function with the identified electronic devices upon instruction from the respective second tier entity.

21. The system of claim 19, wherein the second or an additional tier entity is configured to perform a product and/or service function with a different electronic device based upon the identified electronic device and the identified digital content.

22. A multi-tiered automatic content recognition and processing method, comprising:
in a plurality of second tier entities, receiving from a first tier entity an identity of an electronic device playing digital content, and an identification of the digital content; and
performing a product and/or service function based upon the identified electronic device and the identified digital content, or coordinating with a further tier entity to do so.

23. The method of claim 22, wherein the product and/or service function is performed by transmission of data to the electronic device.

24. The method of claim 22, wherein the product and/or service function is performed by transmission of data to a different electronic device.

25. The method of claim 22, wherein each of the second tier entities provides data to the first tier entity for identification of the digital content.

26. The method of claim 22, wherein each of the second tier entities stipulates to the first tier entity particular digital content to be identified by the first tier entity.

27. A multi-tiered automatic content recognition and processing method, comprising:
in a first tier entity, receiving electronic device data;
analyzing, in the first tier entity, the electronic device data to identify the electronic device and data indicative of digital content being played on the electronic device;
monitoring, in the first tier entity, the data indicative of the digital content to identify the digital content; and
reporting to each of the plurality of second tier entities data indicative of at least a number of incidents of identification of an electronic device and digital content for each respective second tier entity.

28. The method of claim 27, comprising transmitting from the first tier entity to an appropriate one of a plurality of second tier entities the identity of the electronic device and the identity of the digital content to facilitate activity between the second tier entity and the electronic device based upon the identified content.
